(19) United States
(12) Patent Application Publication
(10) Pub. No.: US 2007/0220007 A1
(43) Pub. Date: Sep. 20, 2007

(54) METHOD AND SYSTEM FOR ELECTRONIC AUTHENTICATION

(75) Inventors: Izura Narita, Yamato-shi (JP); Masayuki Takayama, Tokyo (JP)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/685,301

(22) Filed: Mar. 13, 2007

(30) Foreign Application Priority Data
Mar. 17, 2006 (JP) 2006-74883

(51) Int. Cl. G06F 17/30

(52) U.S. Cl. 707/9

(57) ABSTRACT

A method and system for authenticating, in a host managing an electronic site and a site information table, user information inputted by a communication terminal communicably connected to the electronic site. The user information may comprise a dynamic password that corresponds to a static password and is contained in a local information table. Upon receiving user information transmitted by the communication terminal, the host authenticates the user information based on its site information table in order to allow for performing a transaction from the communication terminal. The host changes the user information to update the site information table during a transactable period after authenticating the user information and transmits the changed user information to the communication terminal in order to update the user information at the communication terminal. Upon receiving the changed user information from the host, the communication terminal updates the user information in its local information table accordingly.

### CROSS-REFERENCE TO RELATED APPLICATION

This application claims the priority benefit under 35 U.S.C. § 119 of Japanese application 2006-74883, filed Mar. 17, 2006, and incorporated herein by reference.

### BACKGROUND OF THE INVENTION

1. Field of the Invention

The present invention relates to the technology for protecting an electronic authentication from an illicit act of stealing a password in authentication of a Web site upon performing an electronic commercial transaction. More specifically, the present invention relates to an electronic authentication method and a system thereof for protecting an electronic authentication from the illicit act, such as phishing and skimming, upon performing transactions via the Internet, such as online banking and online stock trading.

2. Description of the Related Art

With the spread of the Internet, the electronic commercial transactions via a network, without the intermediary of personnel, have been expanding. In particular, as for the transactions fully completed in the network, such as financial transactions of banks or securities firms and transactions of electronic contents, expansion of the electronic commercial transactions is astonishing. Personal authentication of the bank or a credit-card transaction during the electronic commercial transaction is also performed without intermediary of personnel. In this electronic commercial transaction, it is necessary to perform personal authentication as safely and simply as in the case of actual transactions.

FIG. 1 illustrates a schematic flow, as an example of the financial transaction, in the case of the online banking and the online stock trading which require the personal authentication. A financial institution, such as a bank and a securities firm, provides a Web banking site 140 which allows the online banking managed by a host computer 150, apart from an actual store, via the Internet 100. A user 110 of “A” bank 150 accesses the Web site of the “A” bank via the Internet 100 by a communication terminal 120, for example, a personal computer (PC), a personal digital assistant, or the like. This Web site is provided with information on various services, such as the financial transaction or the like as those in the actual store. This Web site also displays a login screen 130 (FIG. 2) which allows for access to a user's account. In order to allows for access to the user's account of the “A” bank, the user inputs specific user information, such as an account number (account no.), a password (corresponding to a static password (S-PWD) of the present application), or the like.

FIG. 2 illustrates an example of the inputted items on the login screen 130. The inputted information, such as the user's account number (account no.) and the password, is sent to the system of the “A” bank (for example, the host computer 150) via the Web site 140 for personal authentication. The system 150 of the “A” bank requires authentication as to whether or not the user is a legitimate user to the account from the received user information (the account number and the password). The system 150, which has customer information in its database, searches and refers to the customer information to check whether or not the password (S-PWD) is correct. When it is checked that the password inputted by the user 110 is correct, the system 150 authenticates the user information and provides a notice of the authentication to the user 110. Simultaneously with the authentication, desired transactions are allowed to perform by accessing the user's account in the system 150 of the “A” bank (the completion of login).

In the electronic commercial transaction, such as the online banking, the online stock trading, the online auction, or the like, transfer of money is essential. For example, on performing the personal authentication, personal information, such as a password, is inputted in the input screen of FIG. 2 on the Web site 140 of a certain company to perform the transaction. In this case, if the personal information, such as the password, is leaked to others, it will permit the others to perform the transactions using the password. In particular, antisocial illicit acts, such as “phishing”, which steals the user's password by spoofing a service providing company, or “skimming”, which steals card information, have been recently a major threat.

FIG. 3, in (a) and (b) thereof, illustrates an example of a phishing fraud as an example of the illicit act. It represents the fraud of exploiting a personal identification number (PIN), a credit card number, or the like, by spoofing a legitimate e-mail from a financial institution or a Web site of a financial institution. The e-mail is randomly sent with a sender using a teller window of the financial institution or the like as an address, with a text of guidance which urges the user to input the personal information along with a link to a Web page. When the link is clicked on, the legitimate Web site of the financial institution and a pop-up window for inputting the personal information are displayed. The site displayed on the main window is “genuine”, but the pop-up page is “false.” If the user who is relieved by finding the genuine window inputs the password, the credit card number, or the like into the displayed input screen 130, the information will be sent to an illicit person. In FIG. 3, items a to d are, as follows:
a. It illustrates the case where the false e-mail by the illicit person is linked to the false financial institution site.
b. The user receives the false e-mail.
c. The false link is clicked on, which is not connected to the legitimate site indicated in the e-mail but to the false site.
d. As illustrated in “b”, since the user thinks that the information is sent to the legitimate site, he/she inputs the personal information, such as the account number and the password.

Recently, fraudulent practices have been occurring by the illicit persons who acquire the account number and the password inputted in the login screen of the false Web page using this sequence of a-d.

“Anti-counterfeit only by insertion,” UFJ card, developed technology with Hitachi, Nihon Keizai Shimbun, Sep. 30, 2005 (Friday), 13th edition, page 4 (Non-patent Document 1) provides the technology of measures against skimming. It is to reject the use of a forged card of the illicit person by an owner of the card changing the card information as needed. The skimming is the act of illicitly reading magnetic recording information of the credit card or an ATM card of the others to create and use a “copy (forged card).” The information is copied using a device called a “skimmer”, which reads the card information.

The technology of Non-patent Document 1 is to rewrite the card information by the user (owner) with the communication terminal connected to the system of a card issuer to reject the use of the forged card created previously. It is not certain from the description of the document as to whether or not checking is required by the password upon rewriting the card information. If personal identification by the password is required upon rewriting the card information, the password of the technology disclosed in the above-mentioned document can be considered as the static password (S-PWD). In the case of the above-mentioned document, the terminal used when utilizing the actual card is different from the terminal for changing the card information (corresponding to a dynamic password (D-PWD) of the present invention). If the skimming act occurs without recognition by the user during a period from the change to the use of the card, the use of the forged card cannot be prevented. Moreover, since rewriting of the card information is the arbitrary act by the owner, it is difficult to completely prevent the illicit use of the forged card by the illicit act.

Japanese Unexamined Patent Publication (Kokai) No. 2002-312326 (Patent Document 1) provides an authentication method of propriety of the access to a server computer, various devices, such as a printer, an application program, or the like. It is determined whether or not a target resource can be accessed by connecting the USB memory to the PC to collate the password and the account number in a collation table and a registry file in the storage means which can be included in the PC with those in the USB memory. The USB memory stores and manages the user information, such as the account number and the password, in this authentication method, so that, if the USB memory is stolen, the recorded user information can be read out to create the forged USB memory. The use of the forged USB memory permits access to the target resource and cannot prevent the illicit act. Moreover, the technology of the above-mentioned document is that which cannot determine the propriety of the access to the various devices without connecting the USB memory of the user to the certain PC and cannot ensure an aspect (portability) where the user uses the USB memory by connecting it to the arbitrary PC, so that it is inconvenient.

### SUMMARY OF THE INVENTION

As described above, Non-patent Document 1 is silent as to whether or not two passwords are used. In addition, changing the dynamic password is the arbitrary act by the user. Therefore, if the card is stolen, the illicit act cannot be substantially prevented.

Moreover, the authentication method of Patent Document 1 cannot prevent the access to the target resource using the forged USB memory if the USB memory is stolen and the recorded information is read out to create the forged USB memory. Furthermore, since the computer which authenticates the access use to which a USB device is connected is limited, it is not intended to carry the USB device for conducting the authentication in anywhere, such as with the PC capable of connecting to the network.

Therefore, an object of the present invention is to provide an electronic authentication method and a system thereof, in the authentication of the Web site upon performing an electronic commercial transaction, by which access by a third person to a site is not allowed even when personal information is leaked to the third person by the illicit act.

The present invention which accomplishes the foregoing object is realized by the following electronic authentication method. The method, in a host managing an electronic site and a site information table, for authenticating user information inputted by a communication terminal communicably connected to the electronic site, comprises the steps of: acquiring first information inputted into an input screen of the site in the communication terminal; authenticating the acquired first information based on the site information table; requiring transmission of second information corresponding to the first information from a local information table managed in the communication terminal; receiving the second information to authenticate the second information based on the site information table in order to allow for performing transaction at the site; changing the second information to update the site information table during a transactable period in the site after authenticating the second information; and transmitting the changed second information to the communication terminal in order to update the second information in the local information table.

Also, more specifically, in the foregoing electronic authentication method, the step of updating the second information is performed in response to at least one of a start of the transactable period and a notice of the transaction end from a user.

Preferably, in the foregoing electronic authentication method, the first information is assigned to a specific user.

Preferably, in the foregoing electronic authentication method, the first information is an account number and a static password of the account.

Preferably, in the foregoing electronic authentication method, the second information is assigned to the specific user corresponding to the first information and stored in the local information table managed by the communication terminal of the user.

Preferably, in the foregoing electronic authentication method, the second information serves as a dynamic password which is not recognized by the user.

Preferably, in the foregoing electronic authentication method, the communication terminal includes means for managing the local information table.

Preferably, in the foregoing electronic authentication method, the management means includes a storage unit for storing the local information table.

Preferably, in the foregoing electronic authentication method, the management means is an external device detachably attachable to the communication terminal.

Preferably, in the foregoing electronic authentication method, the external device is at least one of a USB memory and an IC card.

Preferably, in the foregoing electronic authentication method, the communication terminal is at least one of a PC and a personal digital assistant.

The present invention also contemplates a system for performing electronic authentication, as well as a computer program product in the form of a computer-readable medium (such as a semiconductor memory or a magnetic or optical disk) having computer-executable instructions stored thereon which, when executed by a computer, cause the computer to perform the method.

The present invention which accomplishes the foregoing object is realized by the following electronic authentication system. The electronic authentication system performs authentication by a host managing an electronic commercial transaction site and a site information table, using first information inputted by a user in an input screen of the electronic commercial transaction site via a user communication terminal communicably connected to the host. The user is provided with an external device communicably connected to the communication terminal and storing a local information table retaining second information transmitted to the host and corresponding to the first information. The host acquires the first information inputted by the user in the input screen of the site via the communication terminal and the second information, authenticates the acquired first and second pieces of information based on the site information table, changing the second information to update the site information table after the second information is authenticated and during a transactable period in the site, and transmits the changed second information to the communication terminal in order to update the second information in the local information table recorded on the external device connected to the communication terminal.

According to the present invention constituted as described above, in the authentication of the user upon performing an electronic commercial transaction, the electronic authentication makes it possible that any access by an illicit person who steals a password and forges a card can be eliminated.

### BRIEF DESCRIPTION OF THE DRAWINGS

FIG. 1 illustrates a schematic flow, as an example of a conventional financial transaction, in the case of an online banking and an online stock trading which require personal authentication;

FIG. 2 illustrates a displayed login screen to allow for access to a user's account in the online banking;

FIG. 3 illustrates an embodiment of phishing fraud as an example of an illicit act in the online trading;

FIG. 4 illustrates a relation among a physical device, a user, and an act by an illicit person in the authentication method according to one embodiment of the present invention;

FIG. 5 illustrates an example of the sequence (1 to 12) of the personal authentication method in the first embodiment of the present invention; and

FIG. 6 illustrates an example of an external memory including a recording memory 600 recording a local authentication table 610, and an arithmetic circuit 620 generating a D-PWD by considering an S-PWD or the like as a seed.

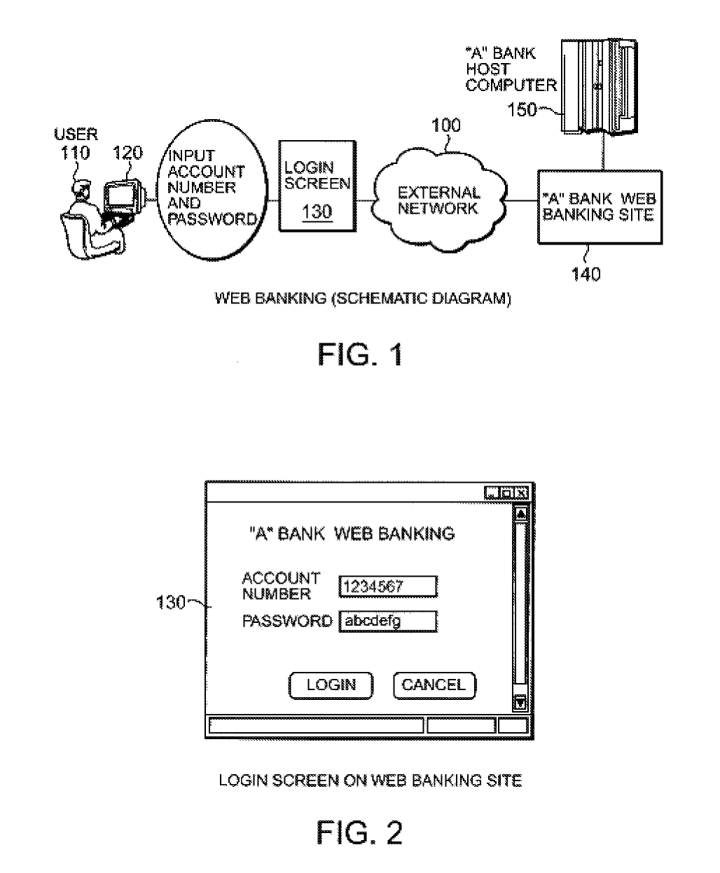

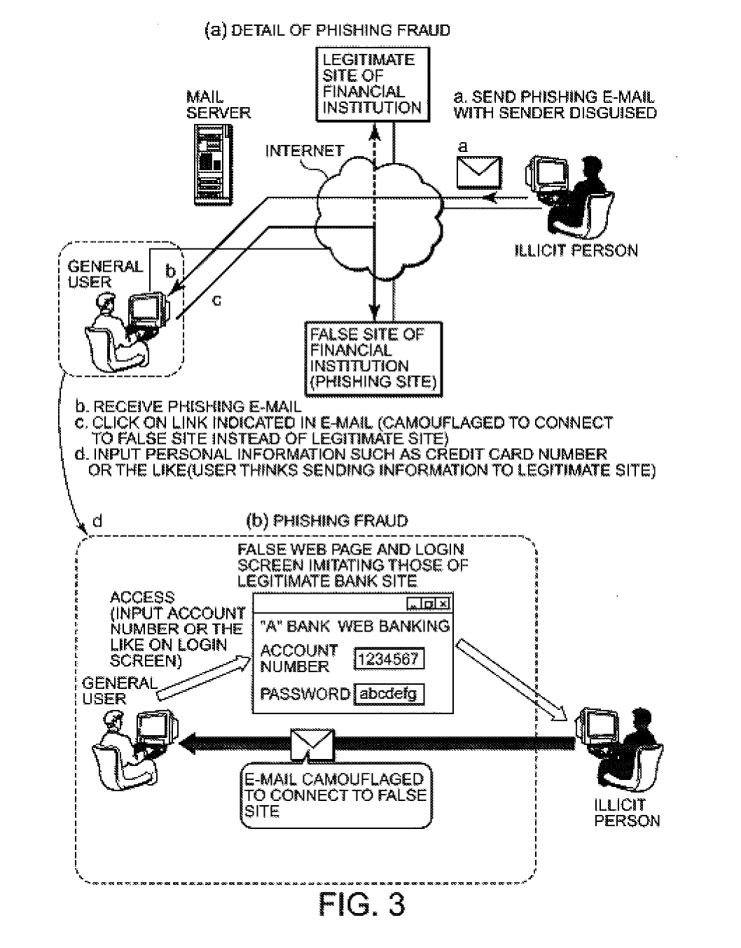

### DETAILED DESCRIPTION OF THE INVENTION

Hereafter, the best mode for carrying out the present invention (hereinbelow, embodiment) will be described in detail by reference to the accompanying drawings.

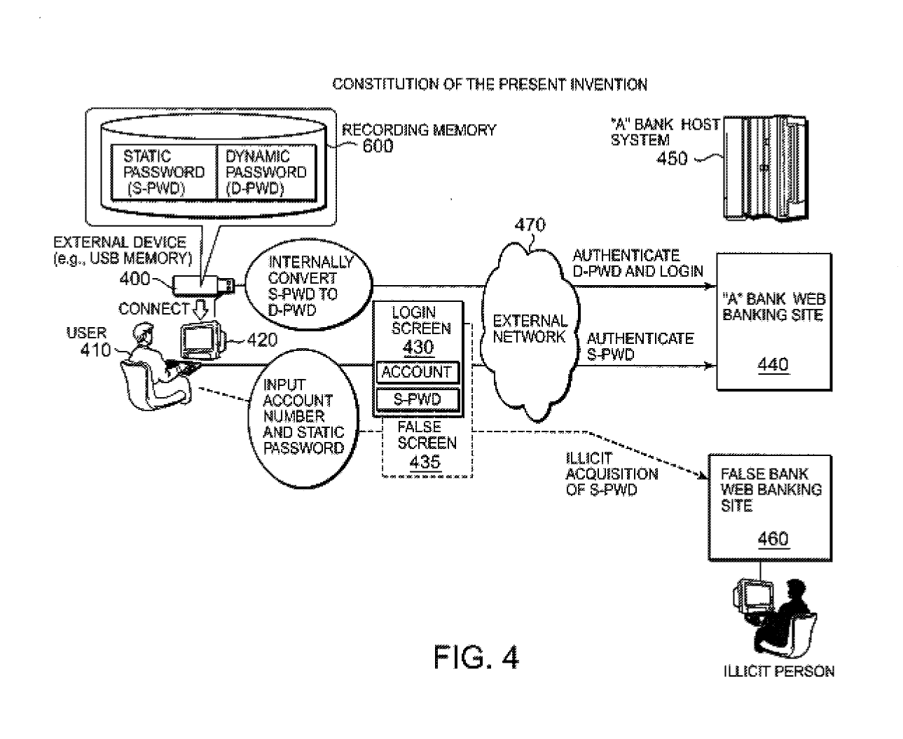

FIG. 4 illustrates a relation among a physical device, a user, and an act by an illicit person by an authentication method according to one embodiment of the present invention.

As shown in FIG. 4, the use embodiment of an online banking which a user 410 uses comprises an external device 400 owned by the user, a communication terminal 420 to which the external device 400 is attached, and a host computer 450 of an “A” bank to which the communication terminal 420 is communicably connected via an external network 470. The user 410 can access the host computer 450 from a Web banking site 440 of the “A” bank. The external device 400 includes a recording memory 600. The recording memory 600 is a non-volatile memory unit. The external device 400 may also include an arithmetic unit including a cipher processing function. A password, corresponding to a static password, is dynamically stored in a storage unit of the external device 400. In the present invention, this password is called a dynamic password (D-PWD) in contrast to the static password. The static password is fixed from a time when it is provided to each user by a financial institution and is not basically changed, and the user manages it. The financial institution provides the user with the external device 400 in which the dynamic password is stored. Alternatively, the dynamic password may be assigned to the user via the network when the user connects the external device to the communication terminal during an initial procedure for an electronic commercial transaction.

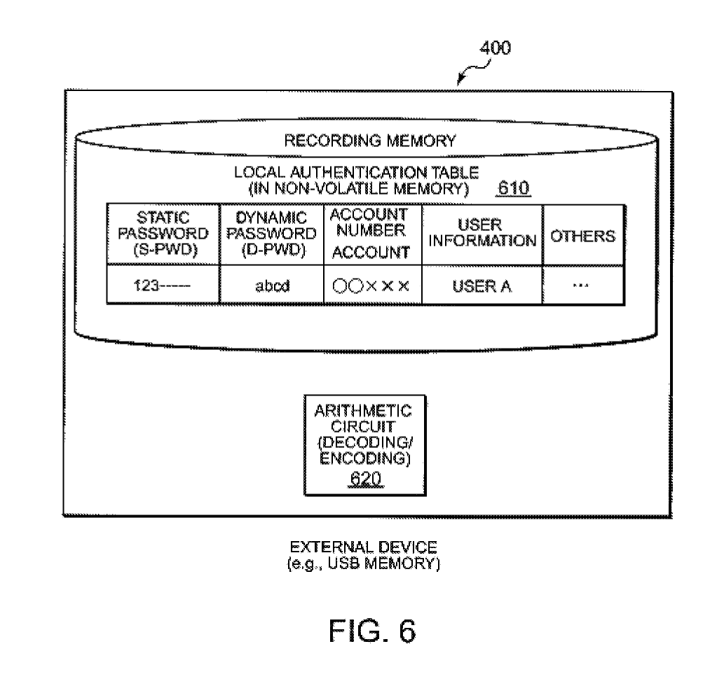

The method of accessing the Web banking site 440 is performed by connecting the external device 400 having the dynamic password (D-PWD) stored therein to the communication terminal 420, for example, a PC or a personal digital assistant. The communication terminal 420 is then connected to the Web site 440 via the Internet, a login screen 430 of the Web site of the “A” bank is displayed on the communication terminal 420. The user 410 inputs an account number or a user ID along with a password which does not fundamentally require to be changed, similarly to the login of the conventional online banking. This password is called the static password (abbreviated to “S-PWD”). In the login screen 430, upon receiving the input of the account number (or the user ID) and the static password (S-PWD), for example, whether or not the dynamic password (D-PWD) corresponding to the static password (S-PWD) is present, is searched from external device 400. The external device 400 has a table 610 of at least the S-PWD and the D-PWD in a non-volatile storage region (see FIG. 6). In addition, the D-PWD may be generated by an arithmetic circuit 620 (encryption circuit unit) (see FIG. 6) by using the inputted account number and the S-PWD as a seed. The generation of the D-PWD by the encryption circuit, instead of being directly recorded, is made in order to prevent the D-PWD corresponding to the S-PWD from being directly and readily read out from the non-volatile memory unit when the external device 400 is lost or stolen.

After the external device 400 is connected to the communication terminal 420, receiving the input of the account number (or the user ID) and the static password (S-PWD), the communication terminal 420 may first authenticate the dynamic password (D-PWD) corresponding to the static password (S-PWD) from the external device 400 (search as to whether or not the corresponding dynamic password (D-PWD) is present). Moreover, before the authentication by the communication terminal 420, the inputted account number and S-PWD may be sent to the host system 450 which manages the Web site 440 of the “A” bank to receive the authentication by the host system 450. Although the former search (the authentication only by the communication terminal) is simpler, the latter authentication (the authentication by the host system followed by the authentication by the communication terminal) is safer in terms of security.

In either case when the communication terminal 420 finds out the relevant D-PWD from the connected external device 400 and authenticates it by itself (the former), or when the authentication is performed by both the host system 450 and the communication terminal 420 (the latter), the D-PWD read out from the external device 400 is sent to the server (host system) 450 which provides the Internet bank site 440. In the Web banking site 440 of the “A” bank, the process is performed as to whether or not the D-PWD can be collated, by associating it with the authenticated account number and S-PWD. The host 450 has a customer table the same as the customer table 610 held in the external device 400, associating the S-PWD with the D-PWD, the authentication of the D-PWD by the host system 450 is the method of checking whether or not the received D-PWD is owned by the legitimate user.

Finally, when the authentication of the D-PWD is completed following the authentication of the S-PWD, the bank system 450 allows the user to perform the transaction at the bank site 440. Since these two authentication sequences of the S-PWD and the D-PWD are performed internally and automatically, the user recognizes that the authentication of only the S-PWD is completed. At least, the user recognizes that the D-PWD is authenticated and an accessed status to the site is allowed during the authenticated period to the legitimate user. The system 450 understands that the accessible period in which the authenticated transaction is possible by the legitimate user is the period in which the D-PWD can be changed. Accordingly, at an appropriate time of the period before the user terminates the transaction, the system 450 changes the D-PWD and sends it to the communication terminal 420, so as to update the D-PWD corresponding to the S-PWD in the external memory connected to the communication terminal 420.

In this manner, when the D-PWD sent from the communication terminal 420 is authenticated by the host 450 which manages the Web site 440 of the “A” bank, the commercial transaction, such as financial transaction, provided by the site is allowed and the D-PWD is changed at the appropriate time during the transactable period. For example, every time an access to the Web banking site is allowed, the D-PWD may be updated at the start of the access or at the end of the transaction. Alternatively, the D-PWD may be newly generated at an arbitrary time during the period from the start to the end of the transaction. In any case, since the user does not recognize owning the D-PWD, the user does not need to recognize that a value thereof is changed, either. Since the user does not need to memorize the D-PWD, the service provider (the host 450) side can lengthen the D-PWD without limit. In other words, the host can set up the D-PWD as needed, which takes time for decoding in terms of the length. Meanwhile, the “A” bank host system on the service providing side has an advantageous effect in that it can change the D-PWD of each user at an appropriate time of the transaction and it does not need to strengthen the security by causing the user to voluntarily change the S-PWD. In this embodiment, the host system 450 changes the D-PWD stored in the external device 400 at the appropriate time, in correspondence with the S-PWD managed by the user, so that the D-PWD is not visually grasped by such as which host system 450 makes correspond to S-PWD managed by the user, and is storing in the external device 400 timely, and is not visually grasped by such as taking a photo by a camera. Moreover, even when phishing of the S-PWD inputted by the user is carried out, phishing of the D-PWD, which the user does not recognize and is not displayed on the screen, is not carried out. Even when someone tries to steal the D-PWD from a network line, the D-PWD is changed at an appropriate time, so that the D-PWD used by the illicit person is likely to be old. Even when the illicit person accesses the “A” bank host system 450 via the Web banking site 440 using the old D-PWD, the access act can be prevented. As described above, the method of using two passwords according to the present invention has an effect to increase the extent to eliminate the illicit act.

As another embodiment, the external device 400 may have an arithmetic circuit (algorithm) to generate the D-PWD, and the external device 400 does not record therein the D-PWD corresponding to the S-PWD. FIG. 6 illustrates an example of the external memory including a recording memory 600 which holds the local authentication table 610 and an arithmetic circuit 620 which generates the D-PWD by using the S-PWD or the like as a seed. The bank host system 450 which provides the service has the same code generation algorithm as the arithmetic circuit held by the external device 400 as software or hardware. The host system 450 considers the user information such as the S-PWD as the seed, for example, and encodes it using the arithmetic circuit to generate the D-PWD. The generated D-PWD is sent to the communication terminal 420, and, when the D-PWD is received, the generated seed may be held in the local authentication table 610, in correspondence with the S-PWD, using the decoding function of the arithmetic circuit held by the communication terminal 420 or the external device 400. The seed for the encryption circuit sent from the host 450 to the communication terminal 420 is recorded as the D-PWD associated with the account number and the S-PWD to update the authentication table 610. The external device 400, for example, the USB memory, directly stores the D-PWD updated by the host system 450. When the external device 400 has the encryption circuit unit 620 in the recording memory 600, the seed may be associated with the S-PWD and the accounting number to store it in the authentication table 610.

In the authentication method of the present invention, the user does not need to recognize or memorize the D-PWD stored in the external memory and the seed which generates it. Furthermore, the user does not need to be conscious of when it is updated. It is sufficient that the user manages the own account number (account no.), the S-PWD, and the external device, for example, the USB memory.

Meanwhile, for the bank “A” which provides the online banking service, the timely illicit act by the illicit person can be eliminated from the viewpoint that it can update the D-PWD at any time. In other words, there is an advantageous effect that the voluntary change of the password by the user helps to avoid damage from the illicit transaction by the illicit person.

The dotted line in FIG. 4 shows a route along which the illicit person acquires the account number and the S-PWD, using a false login screen 435 at a banking site 460, which imitates the legitimate login screen 430, and utilizing the logging in by the user 410. This illicit route shows the aspect of the phishing fraud described above. This illicit person can illicitly acquire the personal information, such as the account number and the S-PWD, inputted to the login 435. Accordingly, it is possible to spoof the user and to perform the operation until it receives the authentication of the S-PWD by the host 450 of the “A” bank. Since the D-PWD is provided without recognition by even the user himself/herself in the personal authentication method of the present invention, it is difficult for the illicit person also to acquire the D-PWD. The D-PWD is held only by the host system 450 of the service provider and the external device 400. More specifically, it is sufficient that there is the local authentication table 610 which stores the information on the D-PWD (the D-PWD itself or the seed for generating it) associated with the S-PWD stored in the external device 400 and the non-volatile memory unit included in the communication terminal 420 and that the host system 450 has the same table.

In the present invention, since the external device (for example, the USB memory) 400 or the communication terminal 420 is used, in addition to the account number or the S-PWD for the online banking, and the external device 400 or the communication terminal 420 is used to generate and record the D-PWD, these three points makes it possible that the financial transaction cannot be performed by the third person (illicit person) because the D-PWD is not known even when the S-PWD is leaked.

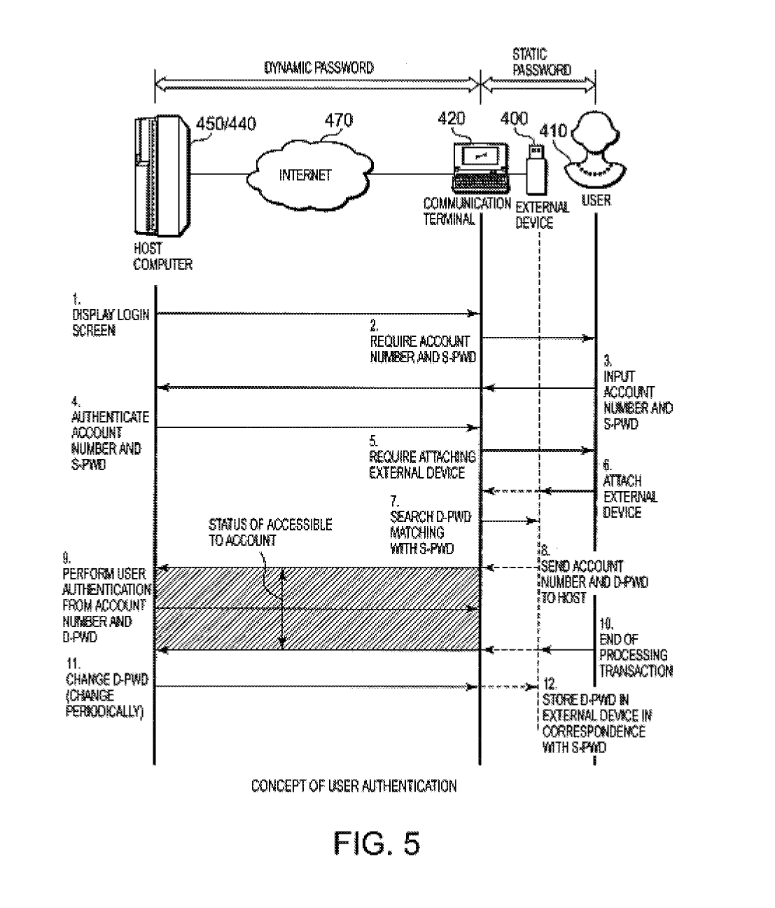

FIG. 5 illustrates an example of a sequence (1 to 12) of the personal authentication method in the first embodiment of the present invention. The external device is typically an external storage (for example, the USB memory) which has connection versatility to the communication terminal. As shown in FIG. 6, the external device may also include the arithmetic circuit 620 for cipher generation in addition to the storage memory 600. In the following sequence, the USB memory holds both the password (S-PWD) which the user himself/herself memorizes and the password (D-PWD) which the host computer uses for the user authentication. The sequence is as follows:
1. First, when the user links to the Web site of the “A” bank, the login screen 430 shown in FIG. 4 is displayed on the communication terminal 420.
2. The Web site 440 requires the user 410 to input the account number and the S-PWD in the login screen 430.
3. The user 410 inputs the account number and the S-PWD in the login screen 430.
4. The Web site 440 refers to the customer table (same as or including the local authentication table 610) managed by the host system 450 to perform authentication processing of the inputted account number and S-PWD. Simply, the S-PWD corresponding to the account number may be authenticated by merely referring to the local authentication table 610 held by the external device without referring to the customer table of the host system 450.
5. The Web site 440 requires attaching the external device to the communication terminal simultaneously with the notice of an authentication result of the S-PWD. If the external device 400 is already attached to the communication terminal at the time of inputting the S-PWD at Step 3, the attaching request is then omitted. The local authentication table 610 is held by the external device 400.
6. The user 410 attaches the external device 400 to the communication terminal 420. If the external device 410 is already attached, this sequence can be omitted.
7. The communication terminal 420 searches the D-PWD associated with the authenticated S-PWD from the external device 400.
8. The communication terminal 420 sends the found D-PWD, the account number, or the like to the Web site 440 (the host system 450).
9. The Web site 440 refers to the customer table held by the host system 450 to authenticate the user from the received account number and D-PWD. When the user authentication is performed by the D-PWD, it is notified to the communication terminal. During the period from this notice to the end of the next Step 10 (shaded area), the user 410 is allowed to perform the various transactions provided by the bank site within his/her account.
10. The user 410 inputs the end of processing of the transaction.
11. When receiving the request of terminating the financial transaction, the Web site 440 changes the D-PWD simultaneously with terminating the transaction and sends the changed D-PWD to the communication terminal. Furthermore, during the period from Step 8 to Step 10, the host system 450 can flexibly select the period in which the D-PWD can be changed in correspondence with the S-PWD.
12. The communication terminal 420 updates the old D-PWD stored in the external device connected to the terminal with the D-PWD sent from the host 450. The host 450 changes the D-PWD and requires the external device for update (11). Then, in the external device, the conversion table 610 of the changed D-PWD and the S-PWD is updated.

Incidentally, FIG. 6 illustrates an illustrative example of the local authentication table 610 in the non-volatile memory 600 in the external memory 400. The host system 450 which manages the bank Web banking site 440 has the customer information substantially including the local authentication table 610.

In the two passwords sequence of the user authentication of the present invention, there is an advantageous effect of high security that the D-PWD can be changed without recognition by the user, managed only by the host system 450 and the external device 400 (or the communication terminal 420), and is not recognized by the user himself/herself and even the illicit person as the third person. In addition, since the D-PWD can be updated every time the transaction is performed, the D-PWD is likely to have been already changed when the local table 610 is copied from the external device and the communication terminal, so that there are more opportunities to prevent the authentication of the illicit person at the Web site. Furthermore, there is an advantage that it is impossible to receive the authentication of the D-PWD if the illicit person does not know the S-PWD even when the external device 400 is stolen. Even when the local authentication table is read out and the S-PWD is leaked, the D-PWD is enciphered to be sent to the host 450, so that it is difficult for the illicit person to receive the final authentication using the stolen external device if the algorithm of the arithmetic circuit of cipher generation is not known.

Although the simplest example has been used in the description above, the external device is not limited to the USB memory as long as it has a recording memory function, such as an IC card, and it includes one that has an encrypting/decoding function as well as the recording memory function. Moreover, although the external device is preferably a portable storage, it may be fixedly attached to the communication terminal. The communicative connection between the host and the communication includes both wired connection and wireless connection. Furthermore, the electronic authentication method of the present invention is not limited to the Web banking, but applicable to any cases where the electronic authentication is required to determine the propriety of the access to the target site in any commercial transaction via the network.

What is claimed is:

1. A method for authenticating, in a host managing an electronic site and a site information table, user information inputted by a communication terminal communicably connected to the electronic site, comprising the steps of:
receiving user information from the communication terminal;
authenticating the received user information based on the site information table in order to allow for performing a transaction from the communication terminal;
changing the user information to update the site information table during a transactable period after authenticating the user information; and
transmitting the changed user information to the communication terminal in order to update the user information at the communication terminal.

2. The method of claim 1, wherein the step of changing the user information is performed in response to at least one of a start of the transactable period and a notice of a transaction end from a user.

3. The method of claim 1, wherein the user information comprises second information corresponding to first information, the method further comprising the initial steps of:
acquiring the first information from the communication terminal;
authenticating the acquired first information based on the site information table; and
requiring transmission of the second information from the communication terminal.

4. The method of claim 1, wherein the user information comprises second information corresponding to first information, wherein the first information is assigned to a specific user, wherein the second information is assigned to the specific user corresponding to the first information.

5. The method of claim 1, wherein the user information comprises second information corresponding to first information, wherein the first information comprises an account number and a static password of an account, and wherein the second information serves as a dynamic password which is not recognized by the user.

6. A computer-readable medium having computer-executable instructions stored thereon which, when executed by a computer, cause the computer to perform the method of claim 1.

7. A method for authenticating user information inputted by a communication terminal communicably connected to an electronic site managed by a host, comprising the steps of:
transmitting user information from the communication terminal to the electronic site for authentication at the electronic site; and
receiving changed user information from the electronic site at the communication terminal;
updating user information at the communication terminal in accordance with the changed user information.

8. The method of claim 7, wherein the user information is transmitted in response to a request from the electronic site.

9. The method of claim 7, wherein the user information comprises second information corresponding to first information, the method further comprising the initial steps of:
transmitting the first information from the communication terminal to the electronic site; and
receiving a request for the second information from the electronic site at the communication terminal.

10. A computer-readable medium having computer-executable instructions stored thereon which, when executed by a computer, cause the computer to perform the method of claim 7.

11. A system for authenticating, in a host managing an electronic site and a site information table, user information inputted by a communication terminal communicably connected to the electronic site, comprising:
means for receiving user information from the communication terminal;
means for authenticating the received user information based on the site information table in order to allow for performing a transaction from the communication terminal;
means for changing the user information to update the site information table during a transactable period after authenticating the user information; and
means for transmitting the changed user information to the communication terminal in order to update the user information at the communication terminal.

12. The system of claim 11, wherein the user information comprises second information corresponding to first information, the system further comprising:
means for initially acquiring the first information from the communication terminal;
means for authenticating the acquired first information based on the site information table; and
means for requiring transmission of the second information from the communication terminal.

13. A system for authenticating user information inputted by a communication terminal communicably connected to an electronic site managed by a host, comprising:
means for transmitting user information from the communication terminal to the electronic site for authentication at the electronic site;
means for receiving changed user information from the electronic site at the communication terminal; and
means for updating user information at the communication terminal in accordance with the changed user information.

14. The system of claim 13, wherein the user information comprises second information corresponding to first information, the system further comprising:
means for initially transmitting the first information from the communication terminal to the electronic site; and
means for receiving a request for the second information from the electronic site at the communication terminal.

15. The system of claim 13, wherein the user information comprises second information corresponding to first information, and wherein the communication terminal authenticates the first information based on a local information table.

16. The system of claim 13, wherein the user information is contained in a local information table managed by the communication terminal.

17. The system of claim 16, wherein the communication terminal includes means for managing the local information table.

18. The system of claim 17, wherein the managing means includes a storage unit for storing the local information table.

19. The system of claim 18, wherein the managing means includes an arithmetic circuit unit for generating the user information.

20. The system of claim 19, wherein the managing means comprises an external storage device detachably connected to the communication terminal.
